(19) United States
(12) Patent Application Publication
(10) Pub. No.: US 2004/0249737 A1
(43) Pub. Date: Dec. 9, 2004

(54) Principled asset rotation

(76) Inventor: Kirk Tofte, Urbandale, IA (US)

Correspondence Address: Davis, Brown, Koehn, Shors & Roberts, P.C., The Financial Center, Suite 2500, 666 Walnut Street, Des Moines, IA, 50309-3993, US

(21) Appl. No.: 10/824,867

(22) Filed: Apr. 15, 2004

Related U.S. Application Data
(60) Provisional application No. 60/464,563, filed on Apr. 22, 2003.

(51) Int. Cl. G06F 17/60

(52) U.S. Cl. 705/35

(57) ABSTRACT

A method of investment for positive returns in both bull and bear markets that involves rotation of investments between at least two types of assets (Class A and Class B) based on the relative performance of two related indexes. If Class A outperforms Class B in the previous time period, the portfolio is invested in Class A assets for the next period of time. If Class B outperforms Class A in the previous time period, the portfolio is invested in Class B assets for the next period of time. The indexes are evaluated after each time period to determine what class the assets are invested in for the next period of time.

### RELATED APPLICATION

Priority is hereby claimed to U.S. Provisional Patent Application No. 60/464,563, filed on Apr. 22, 2003, which is incorporated herein by reference thereto.

### BACKGROUND OF THE INVENTION

1. Field of the Art

The present invention relates generally to a system and method of financial investment for maximizing gains and minimizing losses through rotation of investment between at least two general asset classes. More specifically, the invention relates to rotation of assets between different financial asset classes based on the dominance of one class relative to the other class, or classes, over a predefined period of time.

2. Background of the Art

Investors and investment professionals use a wide array of strategies to manage or allocate resources to maximize the return of an investment portfolio. These strategies range from the very simple to the very complex, however, a typical strategy is to allocate resources between several common classes of investments in a technique called asset allocation. In typical asset allocation programs, assets are split between several classes of investments in some predetermined ratio. Programs of this type are thought to reduce the risk and volatility associated with investments over time. Indeed, this is the principal behind the idea of the mutual fund.

Typical investment classes available to select from include at the highest level of abstraction either stocks or bonds. Stocks represents ownership shares in an ongoing entity usually a corporation, which are usually publicly traded through financial markets worldwide. The return on investment is not fixed and varies depending on a number of factors including the performance of the entity, the general performance of the economy as a whole, to name a few. Bonds on the other hand represent a loan to an entity by the investor. The investor purchases bonds from the entity, with the promise that the loan will be paid back over time at a fixed rate of return. Bonds are also traded through financial markets. Both stocks and bonds as investment vehicles represent an asset to the investor.

These broad classes of investment assets are further subdivided based on the size of the entity, the nature of the entities performance over time and as a function of the entities expected rate of growth. In particular, entities that issue investment asset fall into one of three categories based on size, namely, large-cap, mid-cap, and small-cap. Large-cap entities generally are those that have a market value of about $10 billion or more. The market value of mid-cap entities falls between a range of about $10 billion to $1.5 billion. The market value of small-cap entities is typically less then $1.5 billion.

A further categorization of entities deals with the nature of the entities business. Some industries by nature experience higher rates of growth than others, and usually higher volatility. In other words, some industries grow very rapidly due to the business cycle, or due to the relative maturity of the industry. However, the opposite is often true when business is not good. Stocks issued by these entities fall into the category of growth stocks in that they have a history or higher than average gains relative to other companies or the economy at large. In contrast, other industries experience more steady and slower growth and stocks issued by these entities are deemed value stocks normally issued by well established companies that tend to perform consistently regardless of the general economic state. A further investment class consists of foreign stocks which are issued by companies based outside the United States.

Of course, among these general classes there are many variations, and the categories are not necessarily mutually exclusive. For example, investment asset classes can include mid-cap growth funds, or large cap value funds, and the like. However, the six major stock asset classes are large-cap stocks, mid-cap stocks, small-cap stocks, value stocks, growth stocks, and foreign stocks.

Each of these different investment classes has its own characteristics with regard to growth and return. Some of the classes are more volatile than others, some are more stable, some are highly affected by the general economy and upturn and downturns in the business cycle, while others are generally considered to be insulated from broader economic factors. For this reason, the performance of each of these investments classes is variable relative to the other classes. Thus, the great difficulty with investment schemes, in particular asset allocation programs, is to try and anticipate which of the classes is likely to perform the best and to allocate, and/or reallocate, investment portfolios to take maximize overall return.

The schemes for accomplishing this type of investment rotation are legion, and frequently are tremendously complex. So much so, that the average investor cannot understand or apply most of these schemes on their own, or in some cases even with the assistance of an investment professional. More importantly, many of these plans simply do not produce affective results in terms of allocating resources into higher performing classes of investment.

Accordingly, a need exists for a simply and effective method for allocating assets between investment classes to achieve the highest overall gain on investment.

### SUMMARY OF THE INVENTION

An object of the present invention comprises providing an improved method of allocating assets between investment classes to achieve the highest overall gain on investment.

The investor monitors two stock indexes or other reliable market indicators (Class A and Class B) for an initial period of time to determine which outperforms the other. If Class A outperforms Class B during the initial period, then the investor invests funds of Class A assets for a second period of time, preferably one calendar year. If Class B outperforms Class A for the initial period, then the investor places the investments in founds of Class B. In one embodiment of the invention, Class A is a large-cap growth fund like the S & P 500 Stock Index, and Class B is a small-cap value fund like the Russell 2000 Stock Index. Furthermore, other embodiments comprise a large array of other classes of investments. Investment in these classes of stocks and other assets may be done directly through investment in individual stocks, investment in mutual funds, or through tax-deferred investments.

After the second period of time, the investor re-evaluates the performance of A and Class B during the second period. If the leading Class has changed from A to B or from B to A, the investor also switches his assets to the asset class of the leading Class. If the leading Class remains the same, the investor does nothing until a re-evaluation after a third period of time. The process continues for as many periods of time as the investor wants to continue the method.

These and other objects of the present invention will become apparent to one skilled in the art upon reference to the following specifications, drawings, and claims.

### DETAILED DESCRIPTION OF THE INVENTION

Without wishing to be bound by any particular theory of operation, it is believed that the success of the method of Principled Asset Rotation (PAR) of the present invention is based on three basic economic premises: (1) financial asset classes leadership rotates over time; (2) the rotation of leadership correlates to the business cycle; and (3) financial class leadership and rotation is not totally random and is therefore predictable. Accordingly, the present invention relies on these principals to predict the performance of investment classes such as stocks, bonds, foreign stocks, mutual fund investments, and 401(k) plans and to rotate assets between a limited number of these classes to maximize return on investment.

To illustrate the method of the present invention it is helpful to review the relative performance over time of the four largest asset classes in the United States financial markets. These comprise small-cap value stocks, small-cap growth stocks, large-cap value stocks, and large-cap growth stocks.

TABLE 1
Financial Leadership of Four Major Asset Classes by Year

| YEAR | CLASS LEADER | 2nd BEST CLASS |
|---|---|---|
| 1982 | Small-Cap Value | Large-Cap Growth |
| 1983 | Small-Cap Value | Large-Cap Value |
| 1984 | Large-Cap Value | Large Cap Growth |
| 1985 | Large-Cap Growth | Small-Cap Value |
| 1986 | Large-Cap Value | Large-Cap Growth |
| 1987 | Large-Cap Growth | Large-Cap Value |
| 1988 | Small-Cap Value | Large-Cap Value |
| 1989 | Large-Cap Growth | Large-Cap Value |
| 1990 | Large-Cap Growth | Large-Cap Value |
| 1991 | Small-Cap Growth | Small-Cap Value |
| 1992 | Small-Cap Value | Large-Cap Value |
| 1993 | Small-Cap Value | Large-Cap Value |
| 1994 | Large-Cap Growth | Large-Cap Value |
| 1995 | Large-Cap Growth | Large-Cap Value |
| 1996 | Large-Cap Growth | Large-Cap Value |
| 1997 | Large-Cap Growth | Small-Cap Value |
| 1998 | Large-Cap Growth | Large-Cap Value |
| 1999 | Small-Cap Growth | Large-Cap Growth |
| 2000 | Small-Cap Value | Large-Cap Value |
| 2001 | Small-Cap Value | — |

If leadership was totally random, each class would be expected to lead 25% of the time. However, this is clearly not the case, large-cap growth stocks lead 45% of time, small-cap value stocks lead 35% of the time, large-cap value and small-cap growth stocks each lead 10% of the time. Also clear from the data is the fact that if investments were limited to either large-cap growth stocks or small-cap value stocks, 80% of the time the investor would be invested in the highest returning asset class, provided the investor could accurately predict from year to year which of the two classes would lead.

A review of the relative performance of large-cap growth stocks or small-cap value stock, reveals a second surprising result.

TABLE 2
Financial Leadership of Two Major Asset Classes by Year

| YEAR | LEADER |
|---|---|
| 1982 | Small-Cap Value |
| 1983 | Small-Cap Value |
| 1984 | Large-Cap Growth |
| 1985 | Large-Cap Growth |
| 1986 | Large-Cap Growth |
| 1987 | Large-Cap Growth |
| 1988 | Small-Cap Value |
| 1989 | Large-Cap Growth |
| 1990 | Large-Cap Growth |
| 1991 | Small-Cap Value |
| 1992 | Small-Cap Value |
| 1993 | Small-Cap Value |
| 1994 | Large-Cap Growth |
| 1995 | Large-Cap Growth |
| 1996 | Large-Cap Growth |
| 1997 | Large-Cap Growth |
| 1998 | Large-Cap Growth |
| 1999 | Large-Cap Growth |
| 2000 | Small-Cap Value |
| 2001 | Small-Cap Value |

Large-cap growth stocks lead 60% of the time, and small-cap value stocks lead 40% of the time. This is not far from what would be expected under a totally random system. What, however, is surprising is that leadership rotated between the classes only six times, which is far less than would expect in a system subject only to random variation. Thus, leadership between a small number of equity asset classes is relatively stable, and this stability creates an opportunity to develop an investment strategy based on this discovery. The basis of par is the recognition that leadership between relatively few dominant asset classes rotates infrequently, and therefore rotation of classes predicts significant changes in the economy. Par is based on the assumption that a current time period's class leadership is best predicted by the past time period's leadership. The following table illustrates the par method, and particular using the Multi-Cap or Pure Par method that utilizes the most frequent financial class leaders, large-cap growth and small-cap value.

TABLE 4
Multi-Cap Pure PAR

| | ACTUAL | | | |
|---|---|---|---|---|
| YEAR | CLASS LEADER | PAR CLASS | 2 CL | 4 CL |
| 1982 | Small-Cap Value | — | — | — |
| 1983 | Small-Cap Value | Small-Cap Value | X | X |
| 1984 | Large-Cap Growth | Small-Cap Value | | |
| 1985 | Large-Cap Growth | Large-Cap Growth | X | X |
| 1986 | Large-Cap Growth | Large-Cap Growth | X | |
| 1987 | Large-Cap Growth | Large-Cap Growth | X | X |
| 1988 | Small-Cap Value | Large-Cap Growth | | |
| 1989 | Large-Cap Growth | Small-Cap Value | | |
| 1990 | Large-Cap Growth | Large-Cap Growth | X | X |
| 1991 | Small-Cap Value | Large-Cap Growth | | |
| 1992 | Small-Cap Value | Small-Cap Value | X | X |
| 1993 | Small-Cap Value | Small-Cap Value | X | X |
| 1994 | Large-Cap Growth | Small-Cap Value | | |
| 1995 | Large-Cap Growth | Large-Cap Growth | X | X |
| 1996 | Large-Cap Growth | Large-Cap Growth | X | X |
| 1997 | Large-Cap Growth | Large-Cap Growth | X | X |
| 1998 | Large-Cap Growth | Large-Cap Growth | X | X |
| 1999 | Large-Cap Growth | Large-Cap Growth | X | X |
| 2000 | Small-Cap Value | Large-Cap Growth | | |
| 2001 | Small-Cap Value | Small-Cap Value | X | X |

Starting with the four most dominant equity classes—large-cap growth stocks; large-cap value stocks, small-cap growth stocks, and small-cap value stocks—between the years 1982 and 2001, two classes lead in performance 80% of the time, namely, large-cap mall-cap growth and small cap value stocks. Pure PAR, or Multi-Cap PAR, places 100% of an investors equity shares into one or the other of the two dominant classes each year. The current year's class is selected by determining the past year's leader, again picking between just the two classes. Accordingly, the investment class only rotates when at the end of the year the best performing class for that year is different from the best performing class for the previous year. For example, in 1984 the best performing class, between small-cap value and large-cap growth, was large-cap growth (see Table 3, row 3, col. 2) in 1983 small-cap value was the leading class (see Table 3, row 2, col. 3) so the PAR method selected small-cap value as the preferred investment class for 1984. Under Par, 100% of the 1984 investments would have been placed in small-cap value stocks, which actually turned out to be the lower performing class for that year; therefore, the method would have dictated a switch in investment from 100% small-cap value stocks to 100% large-cap growth stocks for 1985. In 1985, however, the actual class leader was large-cap growth stocks, which matches the current investment choice; therefore, no change would have been made for investment year 1986 (see Table 3, row 4).

Column 4 of Table 3, labeled 2CL, reflects with an X, the years in which Pure PAR accurately predicted the highest performing asset class among the two class leaders utilized in Pure PAR, namely, large-cap growth and small-cap value stocks. As can be seen, Pure PAR predicted the correct result in 13 out of 19 years, or 68% of the time. This is a much better result than the 50% result random chance would predict. However, perhaps and even more surprising result is revealed in column 5 of Table 3, labeled 4CL. This shows the number of times Pure Par selected the highest performing asset class among the original four dominant classes considered in Table 1. This shows Pure PAR was correct 12 out of 19 years, or 63% of the time, far better than the 25% predicted if the process were truly random. This is the case because the two asset classes selected for Pure Par are the most likely to lead, and indeed over the period studied lead 80% of the time. It is worth noting that the one year that Pure PAR predicted the best 2 class selection but not the best 4 class selection (1986), it predicted the second best choice (See Table 1, row 5, col. 3).

Clearly, Pure PAR is a specific example of a general concept that is highly effective in predicting the best investment asset classes between a relatively small number of dominant classes. What is not clear from the foregoing example, but will be made clear herein below in reference to several more specific embodiments of the invention, is that when the actual percentages of growth are considered the results of PAR, and Pure PAR in particular, predict superior returns on investment when compared to other traditional methods of asset allocation.

First, however, the abstract case will case will be considered in order to illustrate the basic principle of the present invention, which comprises an evaluation of the relative performances of the two leading investment class indexes, Class A and Class B, to determine which outperforms the other in previous predefined first period of time. If Index A outperforms Index B during the previous first period of time, then the investor invests substantially all of his/her founds in Class A assets for a second subsequent period of time. If Index B outperforms Index A during the previous first period of time, then the investor places substantially all of his/her investments in funds of Class B. This process repeats in a similar fashion as necessary for as long as the investor wishes. Of course, it is contemplated that the invention can include selecting between more than two classes of investment types.

In the preferred embodiment of the invention, Class A is a large-cap index, preferably a large-cap growth index, in particular, an index like the S & P 500/Barra Growth Index, and Class B is a small-cap index preferably a small-cap value index, in particular, an index like the Russell 2000 Value Index, although other indexes and market monitors can be used with this method. Class A assets tend to be stocks from larger, well-established companies, stocks that are classified as “Growth” stocks, and mutual funds that target such stocks. Class B assets tend to be stocks that are classified as “Value” stocks, stocks from smaller companies, high-quality government and corporate bonds, and mutual funds that invest in such assets. This is not a bright-line classification, as embodiments of the invention can entail rotation between Large-Cap Growth and Large-Cap Value stocks, and percentage investments in both stocks and bonds.

The embodiment of the invention disclosed hereinabove involves rotation of assets from large-cap growth stocks (Class A), to small-cap value stocks (Class B). Due to the high transaction costs of small-cap stocks however, some investors may want to modify this method. One alternative embodiment of the invention entails rotation of investments from individual large-cap growth stocks to investment in individual large-cap value stocks. Another alternative embodiment involves rotation of assets between mutual founds that invest in large-cap growth stocks and mutual founds that invest in large-cap value stocks. These methods eliminate the costs of investing in small-cap stocks and allow the investor to only invest in more liquid, larger company stocks.

The PAR method can also be utilized with 401(k) plans and other tax-free investment opportunities, but the general predictors and methods are the same.

The following discloses more specific examples of various embodiments of the present invention, and includes information relating to relative rates of return for each embodiment.

### EXAMPLE 1

### Multi-Cap Approach

The Multi-Cap approach to PAR involves rotation between large-cap growth stocks (Class A), and small-cap value stocks (Class B). This can be done through investment in individual stocks in each asset class, or through investment in mutual founds. Investment choices are dictated by the performance of the S&P 500 and the Russell 2000 Stock Indexes. In years where during the previous calendar year, the S&P 500 outperformed the Russel 2000, the investor invests 100% of her assets in large-cap growth stocks. In years where, during the previous calendar year, the Russell 2000 outperforms the S&P 500, the investor invests 100% of her assets in small-cap value stocks. The index leader for the 1981 through 2001 is shown in Table 5.

TABLE 5
Multi-Cap Par Specific Index

| YEAR | STOCK INDEX LEADER |
|---|---|
| 1981 | Russell 2000 |
| 1982 | Russell 2000 |
| 1983 | Russell 2000 |
| 1984 | S & P 500 |
| 1985 | S & P 500 |
| 1986 | S & P 500 |
| 1987 | S & P 500 |
| 1988 | Russell 2000 |
| 1989 | S & P 500 |
| 1990 | S & P 500 |
| 1991 | Russell 2000 |
| 1992 | Russell 2000 |
| 1993 | Russell 2000 |
| 1994 | S & P 500 |
| 1995 | S & P 500 |
| 1996 | S & P 500 |
| 1997 | S & P 500 |
| 1998 | S & P 500 |
| 1999 | Russell 2000 |
| 2000 | Russell 2000 |
| 2001 | Russell 2000 |

Following the PAR method, the investor would invest 100% of her assets based on the performance of the stock indexes in Table 5. The investment choice, and rate of return are shown in Table 6. The returns for the Small-Cap Value stocks are measured by the return of the Russell 2000 Value Stock Index, and the returns for the Large-Cap Growth stocks are measured by the S&P 500/BARRA Growth Stock Index. Table 2 also shows the year-by-year changes in value of $10,000 invested on Jan. 1, 1982.

TABLE 6
Multi-Cap PAR Rate of Return

| YEAR | INVESTMENT | RETURNS | $10,000 on Jan. 1, 1982 |
|---|---|---|---|
| 1982 | Russell 2000 | +28.5% | $12,850 |
| 1983 | Russell 2000 | +38.6% | $17,810 |
| 1984 | Russell 2000 | +2.3% | $18,220 |
| 1985 | S & P 500 | +33.3% | &24,287 |
| 1986 | S & P 500 | +14.5% | $27,809 |
| 1987 | S & P 500 | +6.5% | $29,616 |
| 1988 | S & P 500 | +12.0% | $33,170 |
| 1989 | Russell 2000 | +12.4% | $37,358 |
| 1990 | S & P 500 | +0.2% | $37,358 |
| 1991 | S & P 500 | +38.4% | $51,703 |
| 1992 | Russell 2000 | +29.2% | $66,800 |
| 1993 | Russell 2000 | +23.9% | $82,765 |
| 1994 | Russell 2000 | −1.6% | $81,441 |
| 1995 | S & P 500 | +38.1% | $112,470 |
| 1996 | S & P 500 | +23.4% | $139,463 |
| 1997 | S & P 500 | +36.5% | $190,367 |
| 1998 | S & P 500 | +42.2% | $270,702 |
| 1999 | S & P 500 | +28.3% | $347,311 |
| 2000 | Russell 2000 | +22.8% | $426,498 |
| 2001 | S & P 500 | +14.0% | $486,208 |

A negative return was only seen in one year (1994), and that loss was minimal considering the average gain received using PAR. This is significant considering that in the years 1981, 1990, 1994, 2000 and 2001, the stock market as a whole had a return average of −7.8% per year, while PAR generated positive returns that averaged 11.4% per year. An initial investment of $10,000 on Jan. 1, 1982 generated $486,208 by Dec. 31, 2001. The twenty-year return rate on this embodiment was 21.3% compared to only a 14.7% increase in small-cap value stocks, and a 14.8% increase in large-cap growth stocks during this period.

### EXAMPLE 2

### Large-Cap Approach

The avoid problems in the non-liquidity of small company stocks, the PAR method can be accomplished using only large company stocks, and rotating from growth stocks to value stocks. In this approach, in years where the previous year's large-cap value index outperforms the large-cap growth index, assets are placed in large-cap value stocks. In all other years, assets are invested in large-cap growth stocks. Annual returns for this method of investment are shown in Table 7, with large-cap growth returns measurd by the S&P 500/BARRA Growth Stock Index, and large-cap value returns measured by the S&P 500/BARRA Value Stock Index.

TABLE 7
Large Cap PAR

| YEAR | INVESTMENT | RETURNS |
|---|---|---|
| 1982 | Large-Cap Value | +21.0% |
| 1983 | Large-Cap Value | +28.9% |
| 1984 | Large-Cap Value | +10.5% |
| 1985 | Large-Cap Growth | +33.3% |
| 1986 | Large-Cap Growth | +14.5% |
| 1987 | Large-Cap Growth | +6.5% |
| 1988 | Large-Cap Growth | +12.0% |
| 1989 | Large-Cap Value | +26.1% |
| 1990 | Large-Cap Growth | +0.2% |
| 1991 | Large-Cap Growth | +38.4% |
| 1992 | Large-Cap Value | +10.5% |
| 1993 | Large-Cap Value | +18.6% |
| 1994 | Large-Cap Value | −0.6% |
| 1995 | Large-Cap Growth | +38.1% |
| 1996 | Large-Cap Growth | +23.4% |
| 1997 | Large-Cap Growth | +36.5% |
| 1998 | Large-Cap Growth | +42.2% |
| 1999 | Large-Cap Growth | +28.3% |
| 2000 | Large-Cap Value | +6.1% |
| 2001 | Large-Cap Value | −11.7% |

Utilizing this embodiment of the invention, losses were seen in only two calendar years, 1994 and 2001, Despite these losses, rate of return for the period ending Dec. 31, 2001 the annualized returns were 18.3% over the past five years, 17.9% over the past ten years, 17.2% for the past fifteen years, and 18.2% over the past twenty years. These returns were greater than either the large-cap value twenty-year return rate of 15.2%, and the large-cap growth twenty-year return rate of only 14.8%. Similar results are obtained rotating between value stocks and growth stocks for mid-sized companies and small-sized companies, but such investments are generally much less liquid, and involve higher transaction costs, thereby reducing somewhat the overall return value of the investment method.

### EXAMPLE 3

### PAR Stock and Bond (Growth and Income)

Many investors may prefer to invest in a mix of asset classes, rather than invest 100% of assets in one class or another. Thus, historically, stock and bond combined investing allocates about 60% of portfolio assets in stocks and 40% of portfolio invested in bonds at all times. The percentage can vary over time. This process is known as “time weighted asset allocation.” In comparison, the PAR Stock and Bond takes a different approach. If the large-cap index like the S & P 500, or related index, outperforms a small-cap index like the Russell 2000, or related index, in a given year, 100% of portfolio assets are invested in large-cap growth stocks for the following year. In all other years, there is a 100% allocation of assets to government and investment grade corporate bonds. Table 8 shows how the PAR stock and bond investment method would have performed over twenty calendar years. Returns on government and corporate bonds are measured by the Lehman Brothers Aggregate Bond Index, while large-cap growth stock returns are measured by the S&P 500/BARRA Growth Index.

TABLE 8
PAR Stock and Bond (Growth and Income)

| YEAR | INVESTMENT | RETURNS |
|---|---|---|
| 1982 | Government and Corporate Bonds | +6.3% |
| 1983 | Government and Corporate Bonds | +32.7% |
| 1984 | Government and Corporate Bonds | +8.2% |
| 1985 | Large-Cap Growth | +33.3% |
| 1986 | Large-Cap Growth | +14.5% |
| 1987 | Large-Cap Growth | +6.5% |
| 1988 | Large-Cap Growth | +12.0% |
| 1989 | Government and Corporate Bonds | +14.5% |
| 1990 | Large-Cap Growth | +0.2% |
| 1991 | Large-Cap Growth | +38.4% |
| 1992 | Government and Corporate Bonds | +7.4% |
| 1993 | Government and Corporate Bonds | +9.8% |
| 1994 | Government and Corporate Bonds | −2.9% |
| 1995 | Large-Cap Growth | +38.1% |
| 1996 | Large-Cap Growth | +23.4% |
| 1997 | Large-Cap Growth | +36.5% |
| 1998 | Large-Cap Growth | +42.2% |
| 1999 | Large-Cap Growth | +28.3% |
| 2000 | Government and Corporate Bonds | +11.6% |
| 2001 | Government and Corporate Bonds | +8.4% |

This embodiment could also be characterized as a “growth and income find”. It offers downside protection in that losses were only seen in one year out of the 20-year period, which was a 2.9% decrease seen in 1994. For the period ending Dec. 31, 2001, the annualized return for the PAR stock and bond embodiment of the invention were 24.8% for the last five years, 19.4% for the last ten years, 17.3% for the last fifteen years, and 17.7% over the past twenty years.

### EXAMPLE 4

### PAR Bond and Stock (Income and Growth)

The present invention can also be modified to produce an income and growth fund. This utilizes the traditional 60/40 investment approach of stocks to bonds. If in the prior year the Russell 2000 outperforms the S&P 500, then portfolio assets would be 100% invested in high-quality government and corporate bonds. In all other years, asset allocation would be 60% to large company growth stocks and 40% to high quality bonds. Results for this method of investment are shown in Table 9. Returns for bonds are measured by the Lehman Brothers Aggregate Bond Index, and returns for large company growth stocks are measured by the S&P 500/BARRA Growth Index.

TABLE 9
PAR Bond and Stock (Income and Growth

| YEAR | INVESTMENT | RETURNS |
|---|---|---|
| 1982 | Government and Corporate Bonds | +6.3% |
| 1983 | Government and Corporate Bonds | +32.7% |
| 1984 | Government and Corporate Bonds | +8.2% |
| 1985 | 60% Large-Cap Growth Stocks/40% Bonds | +28.8% |
| 1986 | 60% Large-Cap Growth Stocks/40% Bonds | +14.8% |
| 1987 | 60% Large-Cap Growth Stocks/40% Bonds | +5.0% |
| 1988 | 60% Large-Cap Growth Stocks/40% Bonds | +10.4% |
| 1989 | Government and Corporate Bonds | +14.5% |
| 1990 | 60% Large-Cap Growth Stocks/40% Bonds | +3.7% |
| 1991 | 60% Large-Cap Growth Stocks/40% Bonds | +29.4% |
| 1992 | Government and Corporate Bonds | +7.4% |
| 1993 | Government and Corporate Bonds | +9.8% |
| 1994 | Government and Corporate Bonds | −2.9% |
| 1995 | 60% Large-Cap Growth Stocks/40% Bonds | +30.3% |
| 1996 | 60% Large-Cap Growth Stocks/40% Bonds | +15.8% |
| 1997 | 60% Large-Cap Growth Stocks/40% Bonds | +27.5% |
| 1998 | 60% Large-Cap Growth Stocks/40% Bonds | +28.8% |
| 1999 | 60% Large-Cap Growth Stocks/40% Bonds | +16.7% |
| 2000 | Government and Corporate Bonds | +11.6% |
| 2001 | Government and Corporate Bonds | +8.4% |

The downside protection provided by this method is illustrated by the fact that there was only one year of negative returns in 1994, where the negative return was a mere 2.9%. Annualized returns for the period ending Dec. 31, 2001 were 17.9% for the previous five years, 14.7% for the previous ten years, 13.0% for the previous fifteen years, and 14.7% for the previous twenty years.

The rates of return vary depending on the embodiment of the invention, and which asset classes are utilized. Tables 6-9 show a comparative list of the twenty, fifteen, ten, and five-year return rates for a number of the example embodiments in comparison to several traditional stock market indexes.

TABLE 10
Twenty Year Annualized Return Comparison

| RANK | Portfolio or Index | Return |
|---|---|---|
| 1st | PAR Multi-Cap Stocks | 21.3% |
| 2nd | PAR Large-Cap Stocks | 18.2% |
| 3rd | PAR Stock and Bond | 18.1% |
| 4th | Large-Cap Value Stocks | 15.2% |
| 5th | Large-Cap Growth Stocks | 14.8% |
| 6th | PAR Bond and Stock | 14.7% |
| 7th | Small-Cap Value Stocks | 14.7% |
| 8th | Traditional Balanced | 13.5% |
| | Portfolio | |
| 9th | High Quality Bonds | 10.6% |

TABLE 11
Fifteen Year Annualized Return Comparison

| RANK | Portfolio or Index | Return |
|---|---|---|
| 1st | PAR Multi-Cap Stocks | 21.0% |
| 2nd | PAR Stock and Bond | 17.3% |
| 3rd | PAR Large-Cap Stocks | 17.2% |
| 4th | Large-Cap Growth Stocks | 14.1% |
| 5th | PAR Bond and Stock | 13.0% |
| 6th | Large-Cap Value Stocks | 12.9% |
| 7th | Small-Cap Value Stocks | 12.8% |
| 8th | Traditional Balanced | 12.1% |
| | Portfolio | |
| 9th | High Quality Bonds | 10.6% |

TABLE 12
Ten Year Annualized Return Comparison

| RANK | Portfolio or Index | Return |
|---|---|---|
| 1st | PAR Multi-Cap Stocks | 25.1% |
| 2nd | PAR Stock and Bond | 19.4% |
| 3rd | PAR Large-Cap Stocks | 17.9% |
| 4th | Small-Cap Value Stocks | 15.1% |
| 5th | PAR Bond and Stock | 14.7% |
| 6th | Large-Cap Value Stocks | 13.1% |
| 7th | Large-Cap Growth | 12.3% |
| 8th | Traditional Balanced | 10.7% |
| | Portfolio | |
| 9th | High Quality Bonds | 7.2% |

TABLE 13
Five Year Annualized Return Comparison

| RANK | Portfolio or Index | Return |
|---|---|---|
| 1st | PAR Multi-Cap Stocks | 28.3% |
| 2nd | PAR Stock and Bond | 24.5% |
| 3rd | PAR Large-Cap Stocks | 18.4% |
| 4th | PAR Bond and Stock | 17.8% |
| 5th | Traditional Balanced | 12.5% |
| | Portfolio | |
| 6th | Large-Cap Growth Stocks | 11.0% |
| 7th | Small-Cap Value Stocks | 10.9% |
| 8th | Large-Cap Value Stocks | 9.5% |
| 9th | High Quality Bonds | 7.3% |

The number of investment strategies and methods are numerous. Despite this, investors have lost over eight trillion dollars investing in the United States stock market since the year 2000. Investor confidence has plummeted; many have lost significant amounts in the stock market, and seen sizable losses in other investments as well. Many methods of investment are computer based and highly complex, making it difficult for most investors to understand the investment structure and method, and how to best apply it. In general, the majority of these methods cannot protect against the losses caused by bear markets and recessionary periods.

The current invention simplifies the process of investing in the stock market by monitoring one key signal produced out by the stock market each year. This invention is a method of investment dubbed “Principled Asset Rotation” or PAR. This method simplifies the investment process, making it easier to understand, follow, and track results. PAR also allows the investor to stay focused on long-term financial goals, rather than, engaging in stressful and risky impulse buying and selling based on day-to-day changes in the stock market. PAR entails a method that has generated much higher investment returns than any U.S. stock market index has provided over the past two decades. PAR has the capacity to help millions of investors earn much higher, more consistent returns on their equity investments. It has produced returns of twenty percent or more on an annualized basis over the last five, ten, fifteen, and twenty calendar year time periods. For the calendar year periods ending Dec. 31, 2001 the annualized returns for the PAR system were 28.3% over the past five years, 25.1% for the last ten years, 21.1% over the past fifteen years, and 21.3% for the last twenty years. Even during the downturn of the stock market in 2000, when the stock market as a whole decreased 31.1%, the current method showed a positive total return of 41.7%.

The current invention also minimizes investment risk. Of the six sample PAR portfolios analyzed over the past 20 years, four portfolios had only one year of negative returns, these negative returns ranging from −0.6% to −2.9%. The fifth PAR portfolio experienced losses in only two calendar years, and the sixth in only three out of the twenty calendar years.

Another advantage of the current invention is that its simplicity allows it to be used in a variety of situations based on the investors needs. Returns are maximized by the flexibility of the system, which allows the investor to structure their PAR investment strategy based on their financial needs, ability to take risks, transaction costs and taxes. Investors hold onto their assets for at least one year, and usually at least two years, allowing investors to take advantage of reduced Capital Gains tax. The method can be adapted for a variety of investments, including, but not limited to: mutual finds, growth and income funds, income and growth funds, balanced funds asset allocation funds, variable annuity with guaranteed death benefits, bonus variable annuity, variable annuity with guaranteed living benefits, indexed annuity, 401(k), institutional accounts, and hedge funds.

The foregoing description and drawings comprise illustrative embodiments of the present inventions. The foregoing embodiments and the methods described herein may vary based on the ability, experience, and preference of those skilled in the art. Merely listing the steps of the method in a certain order does not constitute any limitation on the order of the steps of the method. The foregoing description and drawings merely explain and illustrate the invention, and the invention is not limited thereto, except insofar as the claims are so limited. Those skilled in the art that have the disclosure before them will be able to make modifications and variations therein without departing from the scope of the invention.

1. An investment method for maximizing return on investment by periodic comparison of performance between classes of financial asset groups, said method comprising the steps of:
selecting at least two classes of financial asset groups at a beginning of a period of time;
measuring the performance of said classes at an end of said period of time to determine a dominant and recessive class in terms of performance over said first period of time;
allocating assets to said dominant class over said recessive class at the end of said period of time; and
repeating said measuring and allocating steps for an indefinite number of periods of time.

2. The invention in accordance with claim 1 wherein said at least two classes of financial asset groups are selected from a group comprising large-cap growth stocks, large-cap value stocks, mid-cap growth stocks, mid-cap value stocks, small-cap growth stocks, small-cap value stocks, corporate bonds, government bonds, municipal bonds, mutual founds, hedge funds, and 401(k).

3. The invention in accordance with claim 1 wherein one of said at least two classes of financial asset groups is a large-cap growth fund, and another one of said at least two classes of financial asset groups is a small-cap value fund.

4. The invention in accordance with claim 1 wherein one of said at least two classes of financial asset groups is a large-cap growth fund, another one of said at least two classes of financial asset groups is a large-cap value fund, one of said at least two classes of financial asset groups is a small-cap growth fund, and another one of said at least two classes of financial asset groups is a small-cap value fund.

5. The invention in accordance with claim 1 wherein one of said at least two classes of financial asset groups is a large-cap growth fund, and another one of said at least two classes of financial asset groups is a large-cap value fund.

6. The invention in accordance with claim 1 wherein one of said at least two classes of financial asset groups is a large-cap fund, another of said at least two classes of financial assets groups is a small-cap fund, and another one of said at least two classes of financial asset groups is a government and investment grade corporate bond fund, wherein said measuring step is performed with same small-cap and said large-cap funds and said allocating step is performed with said large-cap and said government and investment grade corporate bond funds.

7. The invention in accordance with claim 1 one of said at least two classes of financial asset groups is a large-cap fund, another one of said at least two classes of financial asset groups is a small-cap fund, and another one of said at least two classes of financial asset groups is a stock and bond fund, wherein said measuring step is performed with same small-cap and said large-cap finds and said allocating step is performed with said large-cap and said stock and bond funds.

8. The invention in accordance with claim 1 wherein said period of time is one year.

9. The invention in accordance with claim 1 wherein said allocating step involves allocating 100% of assets between said classes.
